(19) United States
(12) Patent Application Publication
(10) Pub. No.: US 2021/0372104 A1
(43) Pub. Date: Dec. 2, 2021

(54) REVERSIBLE PIPE FITTING

(71) Applicant: EBBE AMERICA, LC, Clearfield, UT (US)

(72) Inventors: Lawrence G. Meyers, Clearfield, UT (US); Alden S. Meyers, Clearfield, UT (US)

(21) Appl. No.: 17/322,321

(22) Filed: May 17, 2021

Related U.S. Application Data
(60) Provisional application No. 63/030,712, filed on May 27, 2020.

(51) Int. Cl. E03C 1/12; F16L 21/00

(52) U.S. Cl. CPC E03C 1/12; F16L 21/00

(57) ABSTRACT

A pipe fitting includes a tubular body comprising an inner surface with a first pipe attachment portion formed of a first polymer material and a second pipe attachment portion axially offset from the first pipe attachment portion and formed of a second polymer material. An outer surface includes a drain attachment portion formed of the first polymer material configured to interface with the drain fixture. The tubular body is reversible such that the tubular body is selectively installable on a pipe member with the first pipe attachment portion located toward a terminal of the pipe member or the second pipe attachment portion located toward the terminal end of the pipe member to sealingly attach the inner surface to the pipe member based on a material forming the pipe member and to sealingly attach a drain fixture to the drain attachment portion.

### TECHNICAL FIELD

The disclosure relates to a pipe fitting for use in plumbing applications.

### BACKGROUND

While steel, cast iron, copper and other metal materials have been and are still used as pipe materials in plumbing applications, the use of plastic materials has become the most prevalent. A significant advantage of plastic piping materials over existing alternatives is that plastic piping is relatively easy to mold, cut and/or bond to itself for forming the varying shapes and sizes required for piping through walls, floors, and cabinets in a building. In particular, the ability of plastic material to chemically fuse to itself through solvent bonding dramatically decreases the labor and material costs required for installation and maintenance in plumbing applications.

In solvent bonding, application of an appropriate solvent (commonly referred to as “cement” in plumbing applications) to a thermoplastic material results in a softening of the polymer, and with applied pressure segmental or polymer chain interdiffusion occurs at the bonding junction between two components. When the solvent evaporates the interdiffusion at the bonding junction leaves a fully consolidated bond, essentially interlocking the polymers of each component together. The proper solvent choice for bonding is dependent on the solubility of the chosen thermoplastic in the solvent and the processing temperature.

The two types of plastic pipe most frequently used in plumbing applications are polyvinyl chloride (PVC) and acrylonitrile butadiene styrene (ABS). Like with other plastic materials, plumbing applications using one of PVC pipe or ABS pipe benefit from the advantages of solvent bonding. Unfortunately, problems are encountered in adhering PVC to ABS due to differences in their material properties and related differences in the solvents appropriate for softening the respective polymers. For that reason, when working with PVC pipe, fittings are typically made from PVC; conversely, when working with ABS pipe, fittings used are typically made from ABS. The inventory of fittings which must be maintained due to this problem can be costly. In addition, if a plumber uses the incorrect fitting, leaks and/or damage to the pipe and fitting can occur.

Accordingly, there is a need for a pipe fitting that is compatible with PVC pipe, ABS pipe, and pipe made from other materials.

### SUMMARY

Embodiments of the present disclosure advantageously provide a pipe fitting that is compatible with pipes made of different materials. According to an embodiment, a pipe fitting includes a tubular body comprising an inner surface with a first pipe attachment portion formed of a first polymer material and a second pipe attachment portion axially offset from the first pipe attachment portion and formed of a second polymer material. An outer surface includes a drain attachment portion formed of the first polymer material configured to interface with the drain fixture. The tubular body is reversible such that the tubular body is selectively installable on a pipe member with the first pipe attachment portion located toward a terminal of the pipe member or the second pipe attachment portion located toward the terminal end of the pipe member to sealingly attach the inner surface to the pipe member based on a material forming the pipe member and to sealingly attach a drain fixture to the drain attachment portion.

### BRIEF DESCRIPTION OF THE DRAWINGS

These and other features, aspects, and advantages of the present disclosure will become better understood regarding the following description, appended claims, and accompanying drawings.

FIG. 1 is a cross section of a pipe fitting according to an embodiment.

FIG. 2 is cross section view of a plumbing system including the pipe fitting of FIG. 1 according to an embodiment.

FIG. 3 is a cut away view of a pipe fitting according to another embodiment.

FIGS. 4-6 illustrate installation of a plumbing system including the pipe fitting of FIG. 3 according to an embodiment.

The drawing figures are not necessarily drawn to scale, but instead are drawn to provide a better understanding of the components, and are not intended to be limiting in scope, but to provide exemplary illustrations. The figures illustrate exemplary configurations of drain systems, and in no way limit the structures or configurations of a drain system and components according to the present disclosure.

### DETAILED DESCRIPTION OF VARIOUS EMBODIMENTS

A better understanding of different embodiments of the disclosure may be had from the following description read with the accompanying drawings in which like reference characters refer to like elements.

While the disclosure is susceptible to various modifications and alternative constructions, certain illustrative embodiments are in the drawings and are described below. It should be understood, however, that there is no intention to limit the disclosure to the specific embodiments disclosed, but on the contrary, the intention covers all modifications, alternative constructions, combinations, and equivalents falling within the spirit and scope of the disclosure.

It will be understood that unless a term is expressly defined in this application to possess a described meaning, there is no intent to limit the meaning of such term, either expressly or indirectly, beyond its plain or ordinary meaning.

Embodiments of the present disclosure advantageously provide a pipe fitting that is compatible with polyvinyl chloride (PVC) pipe, acrylonitrile butadiene styrene (ABS) pipe, and pipe made of other materials. While the pipe fittings of the present disclosure are generally described as adapters, it will be appreciated that the pipe fittings can be configured as elbows, tees, couplings, line clean outs, traps, in-line backwater valves, and/or other forms of pipe connectors.

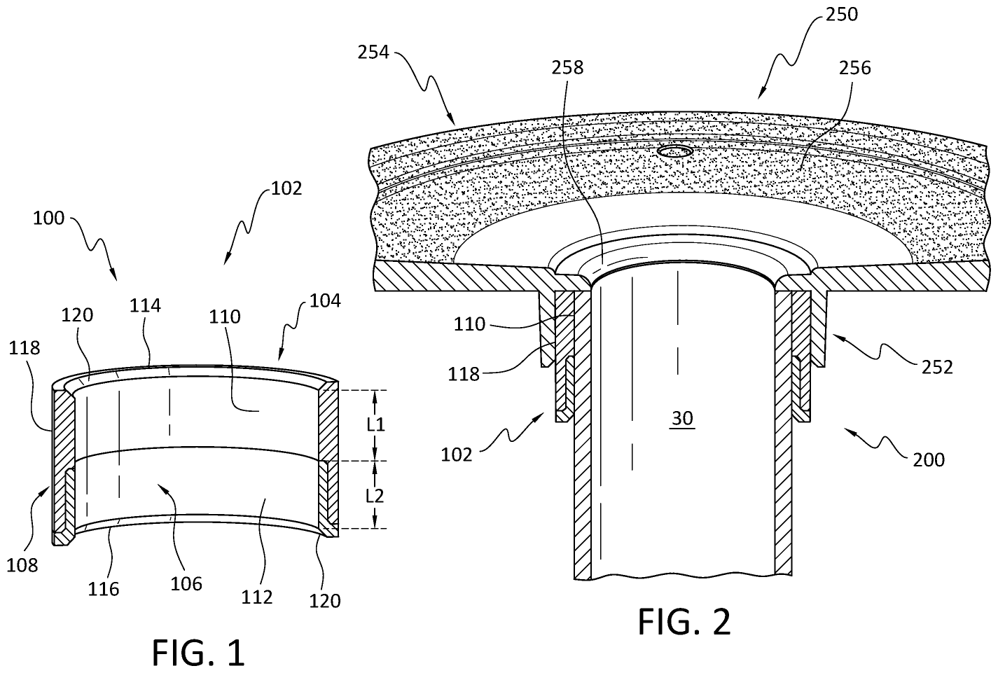

FIG. 1 shows a pipe fitting 100 comprising an adapter 102 configured to attach a drain fixture to a pipe member. In the illustrated embodiment, the adapter 102 includes a tubular body 104 defining an inner surface 106 configured to interface with the pipe member, and an outer surface 108 facing away from the inner surface 106 and configured to interface with and the attach the adapter 102 to a drain fixture or another fitting.

The inner surface 106 includes a first pipe attachment portion 110 formed of a first polymer material and a second pipe attachment portion 112 axially offset from the first pipe attachment portion 110 and formed of a second polymer material. Each of the first and second pipe attachment portion 110, 112 can extend circumferentially around the tubular body 104. In the illustrated embodiment, the first polymer material and the second polymer material are different. For instance, the first polymer material can comprise ABS and the second polymer material can comprise PVC. As seen, the first pipe attachment portion 110 of the inner surface 106 can extend from a first end 114 of the tubular body 104, and the second pipe attachment portion 112 can extend from a second end 116 of the tubular body 104 toward the first pipe attachment portion 110. According to an embodiment, a drain attachment portion 118 of the outer surface 108 is formed of a same material forming the first pipe attachment portion 110 on the inner surface 106. The drain attachment portion 118 can extend along all or substantially all the length of the outer surface 108.

The adapter 102 has a reversible configuration and can be sealingly attached to the pipe member 30 and the drain fixture. For instance, the adapter 102 can be installed on an outer surface of a pipe member 30 (shown in FIG. 2) by inserting the pipe member through the first end 114 or the second end 116. This allows the adapter 102 to be attached to the pipe member 30 with the first pipe attachment portion 110 located toward a terminal end of the pipe member or with the second pipe attachment portion 112 located toward the terminal end of the pipe member. If the pipe member 30 is an ABS pipe member, the adapter 102 can be attached to the pipe member 30 with the first pipe attachment portion 110 formed of ABS located toward the terminal end of the pipe member 30 and ABS cement applied between and/or around the outer surface of the pipe member 30 and the first pipe attachment portion 110. This arrangement can form a watertight seal between the adapter 102 and the pipe member 30. The first pipe attachment portion 110 can have a first attachment length L1 configured to form a sufficient attachment area between the first pipe attachment portion 110 and an ABS pipe member, improving the reliability of the watertight seal.

If the pipe member 30 is a PVC pipe member, the adapter 102 can be turned 180 degrees and attached to the pipe member 30 with the second pipe attachment portion 112 formed of PVC located toward the terminal end of the pipe member so that PVC cement can be applied between the outer surface of the pipe member 30 and the second pipe attachment portion 112. This arrangement can form a reliable, watertight seal between the adapter 102 and the pipe member using the PVC cement. The adapter 102 advantageously allows a drain fixture to be attached to either ABS pipe or PVC pipe using a same adapter rather than requiring multiple adapters, highly specialized solvents or complicated attachment systems, as in the prior art. This simplifies and increases the versatility of the drain system, which, in turn, streamlines installation processes.

According to an embodiment, the adapter 102 comprises an injection molded ABS part forming the first pipe attachment portion 110 on the inner surface 106 and the drain attachment portion 118 on the outer surface 108, and a molded PVC insert forming the second pipe attachment portion 112 on the inner surface 106. For instance, the injection molded ABS part can be molded onto the already formed PVC insert. An interface between the ABS part and the PVC insert may be watertight, through the formation of a tight mechanical connection, interdiffusion or chemical bonds between the materials at the interface. Optionally, one or more chamfers 120 or rounded corners can be formed at the transition between the inner surface 106 and the first and second ends 114, 116 of the tubular body 104. The one or more chamfers 120 can help guide or direct the terminal end of the pipe member 30 into the opening of the tubular body 104.

According to an embodiment, the first pipe attachment portion 110 can have a first attachment length L1 configured to form a sufficient attachment area between the first pipe attachment portion 110 and an ABS pipe member to form a reliable, watertight seal between the adapter 102 and the ABS pipe member using an appropriate adhesive. Similarly the second pipe attachment portion 112 can have a second attachment length L2 configured to provide a sufficient attachment area between the second pipe attachment portion 112 and a PVC pipe member to form a reliable, watertight seal between the adapter 102 and the PVC pipe member using an appropriate adhesive.

In an embodiment, the first attachment length L1 and the second attachment length L2 can be the same or substantially the same. In other embodiments, the first attachment length L1 and the second attachment length L2 can be different. For instance, the first attachment length L1 can be shorter than the second attachment length L2 when creating a bond with the adapter 102 and a PVC pipe is more intensive and sensitive than creating a bond with the adapter 102 and an ABS pipe. In other embodiments, the first attachment length L1 and the second attachment length L2 and/or the first and second polymer materials can be selected based on the application of the adapter 102. For example, the first polymer material and the first attachment length L1 can be selected for use in a hot-water application, and the second polymer material and the second attachment length L2 can be selected for use in a cold-water application.

FIG. 2 illustrates a drain system 200 including a drain fixture 250 formed of ABS attached to the pipe member 30 formed of ABS via the adapter 102 according to an embodiment. The drain fixture 250 can comprise a drain body including a lower portion 252 comprising a collar defining an outlet and configured to mate with the adapter 102, and an upper portion 254 having a circular configuration defining an inlet and a flange 256 surrounding the inlet.

As seen, the adapter 102 can be positioned on the outer surface of the pipe member 30 with the first pipe attachment portion 110 located at or near the terminal end of the pipe member 30. As discussed above, the first pipe attachment portion 110 can be formed of ABS and an ABS cement can be applied between and/or around the outer surface of the pipe member 30 (also formed of ABS) and the first pipe attachment portion 110, which, in turn, forms a watertight seal between the adapter 102 and the pipe member 30. Further, the first attachment length L1 of the first pipe attachment portion 110 provides a greater attachment area between the adapter 102 and the pipe member 30, which, in turn, improves the reliability of the seal.

The lower portion 252 of the drain fixture is sized and configured to be positioned on the drain attachment portion 118 along the outer surface 108 of the adapter 102. The drain attachment portion 118 can be formed of ABS such that an ABS cement can be applied between and/or around the drain attachment portion 118 and the lower portion 252 (also formed of ABS), forming a watertight seal between the adapter 102 and the lower portion 252. The adapter 102 can thus form a watertight connection between the pipe member 30 formed of ABS and the drain fixture 250 formed of ABS.

If the pipe member 30 is formed of PVC, the adapter 102 can be installed on the pipe member 30 with the second pipe attachment portion 112, also formed of PVC, located at or near the terminal end of the pipe member 30 to facilitate the formation of a watertight connection between the adapter 102 and the drain fixture 250. For instance, a PVC cement can be applied between the second pipe attachment portion 112 and the pipe member 30 and the lower portion 252 of the drain fixture 250 can be installed on the drain attachment portion 118 of the adapter 102 using ABS cement as discussed above, forming a watertight seal between the adapter 102 and the drain fixture 250. The adapter 102 can thus be connected to the drain fixture 250 with first pipe attachment portion 110 or the second pipe attachment portion 112 positioned between the lower portion 252 and the pipe member 30, beneficially allowing the drain fixture 250 to be attached to either ABS pipe or PVC pipe using the same adapter 102. In the illustrated embodiment, the adapter 102 can define a thickness between the pipe attachment portion and the drain attachment portion configured to fill a gap between the outer surface of the pipe member 30 and the lower portion 252 of the drain fixture.

According to an embodiment, the upper portion 254 of the drain fixture 250 includes a recessed portion 258 extending around and over the terminal end of the pipe member 30 such that the diameter of the inlet of the drain fixture 250 generally corresponds to the inner diameter of the pipe member 30. The recessed portion 258 beneficially helps locate the drain fixture 250 on the pipe member 30. It also provides a physical barrier between water entering the pipe member 30 through the drain fixture 250 and the adapter 102, helping to prevent the water from leaking between the adapter 102 and the outer surface of the pipe member 30 in the event the seal formed between the adapter 102 and the pipe member 30 was compromised.

While the drain fixture 250 is described as being formed of ABS, it will be appreciated that in other embodiments the drain fixture 250 can be formed of PVC and the drain attachment portion 118 of the adapter 102 can be formed of PVC compatible for bonding with the drain fixture 250, thus allowing the adapter 102 to attach a PVC drain fixture to ABS pipe or PVC pipe.

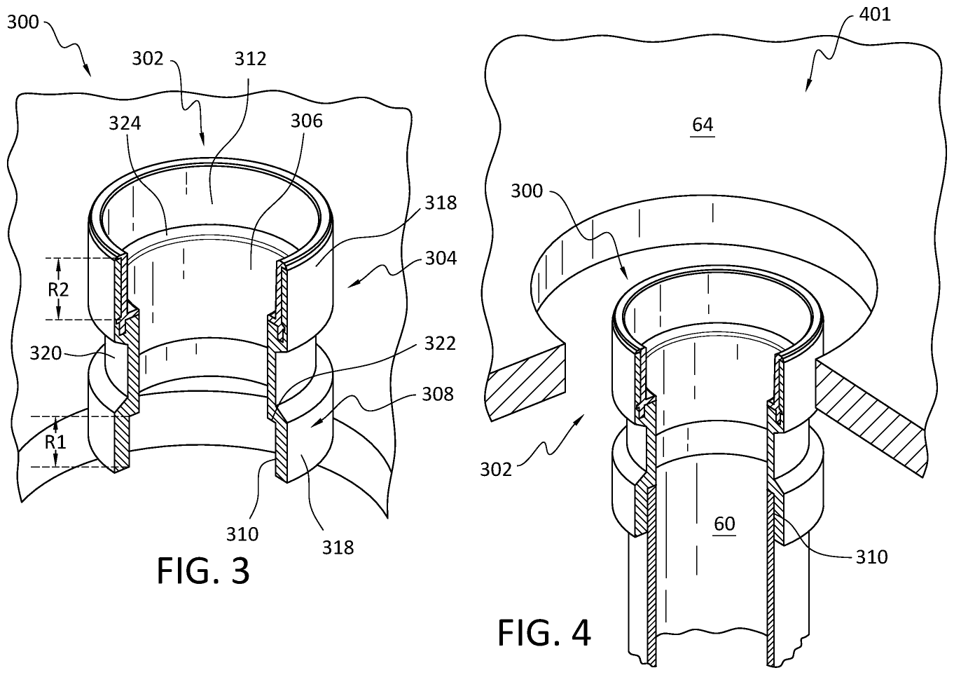

FIG. 3 illustrates a pipe fitting 300 according to another embodiment. Like in other embodiments, the pipe fitting 300 can comprise an adapter 302 configured to attach a drain fixture to a pipe member. The adapter 302 includes a tubular body 304 defining an inner surface 306 having a first pipe attachment portion 310 formed of a first polymer material, and a second pipe attachment portion 312 axially offset from the first pipe attachment portion 310 and formed of a second polymer material. The first pipe attachment portion 310 can define a first attachment length R1. The second pipe attachment portion 312 can define a second attachment length R2.

The tubular body 304 also includes an outer surface 308 facing away from the inner surface 306 and include a drain attachment portion 318 configured to interface with and attach the adapter 302 to the drain fixture. The first polymer material can comprise an ABS material, and the second polymer material can comprise a PVC material. In an embodiment, the adapter 302 comprises an injection molded ABS part forming the first pipe attachment portion 310 on the inner surface 306 and the drain attachment portion 318 on the outer surface 308, and a molded PVC insert forming the second pipe attachment portion 312 on the inner surface 306. For instance, the injection molded ABS can be molded unto the already formed PVC insert. An interface between the ABS part and the PVC insert may be watertight, through the formation of a tight mechanical connection, interdiffusion or chemical bonds between the materials at the interface. In an embodiment, the outer surface 308 can include a recessed portion 320. For instance, the recessed portion 320 can be located between two segments of the drain attachment portion 318 along the outer surface 308.

The adapter 302 has a reversible configuration. In use, the adapter 302 can be installed on a pipe member (shown in FIG. 4) with the first pipe attachment portion 310 or the second pipe attachment portion 312 oriented toward a terminal end of the pipe member 60 depending on the material forming the pipe member 60. A drain fixture formed of a same material (e.g., the first or second polymer material) as the drain attachment portion 318 of the adapter 302 can be installed on the drain attachment portion 318. This advantageously allows the drain fixture to be attached to the pipe member 60 formed of the first polymer material or the second polymer material using the adapter 302.

According to a variation, the first pipe attachment portion 310 can define a first shoulder 322 or abutment, and the second pipe attachment portion 312 can define a second shoulder 324 or abutment. The first shoulder 322 and the second shoulder 324 can provide a stop or limit movement of the pipe member 60 within the adapter 302. It can also offer an index or indicator so that an installer can tell whether the pipe member 60 has been fully or properly inserted into the adapter 302 when installing the adapter 302. In the illustrated embodiment, the adapter 302 can define a thickness between the pipe attachment portion and the drain attachment portion configured to fill a gap between the outer surface of the pipe member and the lower portion of a drain fixture.

An exemplary installation of a drain system including the adapter 302, the pipe member 60, and a drain fixture 650 according to an embodiment will now be described referring to FIGS. 4-6. A step 401 can include installing the adapter 302 on the pipe member 60 within a hole in a subfloor 64 as shown in FIG. 4. Step 401 can include installing the adapter 302 on the pipe member 60 with the first pipe attachment portion 310 oriented toward the terminal end of the pipe member 60 if the first pipe attachment portion 310 and the pipe member 60 are formed of a same polymer material. For instance, both can be formed of ABS.

Step 401 can include installing the adapter 302 on the pipe member 60 until the terminal end of the pipe member 60 engages with the first shoulder 322 of the first pipe attachment portion 310, helping to ensure that the adapter 302 is properly installed on the pipe member 60. Step 401 can include installing the adapter 302 on the pipe member 60 with the second pipe attachment portion 312 oriented toward the terminal end of the pipe member 60 if the second pipe attachment portion 312 and the pipe member 60 are formed of a same polymer material. For instance, both can be formed of PVC.

Step 401 can include applying ABS cement to the pipe member 60 and/or the first pipe attachment portion 310 if the pipe member 60 is formed of ABS. Step 401 can include applying PVC cement to the pipe member 60 and/or the second pipe attachment portion 312 if the pipe member 60 is formed of PVC.

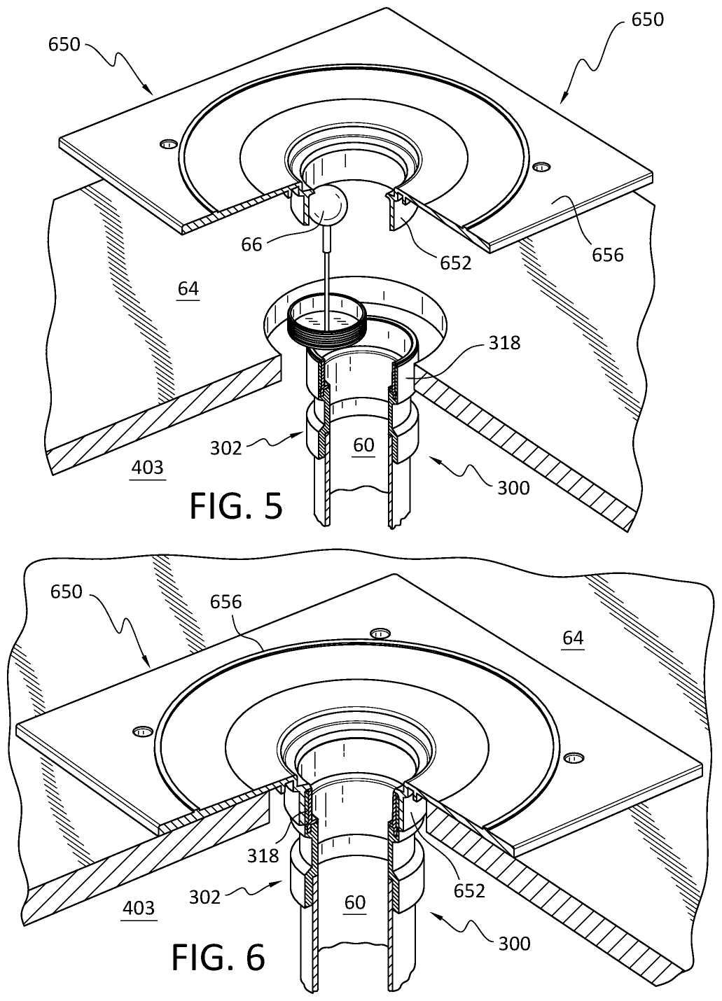

A step 403 can include installing the drain fixture 650 on the adapter 302 attached to the pipe member 60. Step 403 can include installing the drain fixture 650 on the drain attachment portion 318 of the adapter 302. Step 403 can include applying polymer cement 66 to the inside of the lower portion 652 of the drain fixture 650 and/or the drain attachment portion 318 as shown in FIG. 5. In an embodiment, the polymer cement 66 can comprise ABS cement if the lower portion 652 and the drain attachment portion 318 are formed of ABS as shown in FIG. 5. In other embodiments, the polymer cement 66 can comprise PVC cement if the lower portion 652 and the drain attachment portion 318 are formed of PVC.

Step 403 can include installing the drain fixture 650 on the adapter 302 until an underside of the flange 656 of the drain fixture 650 interfaces with the subfloor 64 as shown in FIG. 6. In the illustrated embodiment, the drain fixture 650 is attachable to different locations on the drain attachment portion 318. For instance, the drain attachment portion 318 defines an outermost portion of the outer surface such that the lower portion 652 of the drain fixture 650 can freely move downward along the drain attachment portion 318 until an underside of the flange 656 interfaces with the subfloor 64. This beneficially allows the vertical position of the drain fixture 650 on the subfloor 64 to be adjusted as needed relative to the adapter 302. Optionally, step 403 can include stabilizing the vertical position of the pipe member 60 during installation of the drain fixture 650 on the adapter 302.

As illustrated above, embodiments of the present disclosure thus provide a pipe fitting that is compatible with PVC pipe, ABS pipe, and pipe made of other materials. The reversible configuration of the pipe fitting also beneficially allows drain fixtures and pipe members of different materials to be easily and quickly attached together that have been previously incompatible or complicated to connect, which, in turn, streamlines drain systems and installations thereof.

The various aspects and embodiments disclosed herein are for purposes of illustration and are not intended to be limiting. For instance, while the pipe fittings of the present disclosure are generally described as adapters, it will be appreciated that the pipe fittings can be configured as elbows, tees, couplings, line clean outs, traps, in-line backwater valves, and/or other forms of pipe connectors. In other embodiments, the pipe attachment portions can be located along the outer surface of the pipe fitting and drain attachment portion can be located on the inner surface of the pipe fitting. In other embodiments, the first pipe attachment portions can be formed of a metal material. Additionally, the words “including,” “having,” and variants thereof (e.g., “includes” and “has”) as used herein, including the claims, shall be open ended and have the same meaning as the word “comprising” and variants thereof (e.g., “comprise” and “comprises”).

1. A pipe fitting for attaching a drain fixture to a pipe member, the pipe fitting comprising:
a tubular body comprising:
an inner surface having a first pipe attachment portion formed of a first polymer material and a second pipe attachment portion axially offset from the first pipe attachment portion and formed of a second polymer material; and
an outer surface having a drain attachment portion formed of the first polymer material and configured to interface with the drain fixture,
wherein the tubular body is reversible such that the tubular body is selectively installable on the pipe member with the first pipe attachment portion located toward a terminal end of the pipe member when a material forming the pipe member is a same material as the first polymer material and with the second pipe attachment portion located toward the terminal end of the pipe member when the material forming the pipe member is a same material as the second polymer material to sealingly attach the inner surface to the pipe member and to sealingly attach the drain fixture to the drain attachment portion.

2. The pipe fitting of claim 1, wherein the first polymer material comprises acrylonitrile butadiene styrene (ABS).

3. The pipe fitting of claim 1, wherein the second polymer material comprises polyvinyl chloride (PVC).

4. The pipe fitting of claim 1, wherein the first polymer material comprises PVC.

5. The pipe fitting of claim 1, wherein the second polymer material comprises ABS.

6. The pipe fitting of claim 1, wherein the material forming the pipe member is a same material as the first polymer material.

7. The pipe fitting of claim 1, wherein the material forming the pipe member is a same material as the second polymer material.

8. The pipe fitting of claim 1, wherein the first pipe attachment portion and the drain attachment portion comprise an injection molded ABS part, and the second pipe attachment portion comprises a PVC insert.

9. The pipe fitting of claim 8, wherein the injection molded ABS part is formed on the PVC insert.

10. The pipe fitting of claim 1, wherein the first pipe attachment portion defines a first attachment length along the inner surface, and the second pipe attachment portion defines a second attachment length along the inner surface.

11. The pipe fitting of claim 10, wherein the first attachment length and the second attachment length are a same length.

12. The pipe fitting of claim 10, wherein the first attachment length and the second attachment length are different.

13. The pipe fitting of claim 1, wherein the first pipe attachment portion defines a first shoulder configured to provide a stop or limit movement of the terminal end of the pipe member within the tubular body.

14. The pipe fitting of claim 1, wherein the second pipe attachment portion defines a second shoulder configured to provide a stop or limit movement of the terminal end of the pipe member within the tubular body.

15. The pipe fitting of claim 1, wherein the drain fixture is attachable to different locations on the drain attachment portion of the tubular body.

16. A drain system comprising:
a drain fixture including a lower portion formed of a first polymer material; and
a pipe fitting for connecting the drain fixture to a pipe member, the pipe fitting comprising:
a tubular body comprising:
an inner surface having a first pipe attachment portion formed of the first polymer material and a second pipe attachment portion axially offset from the first pipe attachment portion and formed of a second polymer material different than the first polymer material; and
an outer surface having a drain attachment portion formed of the first polymer material and configured to interface with the drain fixture,
wherein the pipe fitting is reversible such that the tubular body is selectively installable on the pipe member with the first pipe attachment portion located toward a terminal end of the pipe member when a material forming the pipe member is a same material as the first polymer material and with the second pipe attachment portion located toward the terminal end of the pipe member when the material forming the pipe member is a same material as the second polymer material to sealingly attach the inner surface to the pipe member and to sealingly attach the drain fixture to the drain attachment portion.

17. The drain system of claim 16, wherein the first polymer material comprises ABS and the second polymer material comprises PVC.

18. The drain system of claim 16, wherein the first polymer material comprises PVC and the second polymer material comprises ABS.

19. A method of attaching a drain fixture including a lower portion formed of a first polymer material to a pipe member, the method comprising:
providing a pipe fitting comprising:
a tubular body including:
an inner surface having a first pipe attachment portion formed of the first polymer material and a second pipe attachment portion axially offset from the first pipe attachment portion and formed of a second polymer material; and
an outer surface having a drain attachment portion formed of the first polymer material and configured to interface with the drain fixture;
attaching the pipe fitting to a terminal end of the pipe member, wherein the pipe fitting is reversible such that the tubular body is selectively installable on the pipe member with the first pipe attachment portion located toward the terminal end of the pipe member when a material forming the pipe member is a same material as the first polymer material and with the second pipe attachment portion located toward the terminal end of the pipe member when the material forming the pipe member is a same material as the second polymer material; and
attaching the drain fixture to the drain attachment portion of the pipe fitting.

20. The method of claim 19, wherein the second polymer material comprises PVC.
